(19) United States
(12) Patent Application Publication
(10) Pub. No.: US 2020/0166785 A1
(43) Pub. Date: May 28, 2020

(54) ULTRAVIOLET ALIGNMENT ILLUMINATION SYSTEM AND DETECTION DEVICE FOR SAME

(71) Applicants: HKC CORPORATION LIMITED, Shenzhen City, Guangdong (CN); CHONGQING HKC OPTOELECTRONICS TECHNOLOGY CO., LTD., Chongqing (CN)

(72) Inventors: Yuntao TANG, Chongqing (CN); Hung-Yu CHEN, Chongqing (CN)

(73) Assignees: HKC Corporation Limited, Shenzhen City, Guangdong (CN); Chongqing HKC Optoelectronics Technology Co., Ltd., Chongqing (CN)

(21) Appl. No.: 16/342,068

(22) PCT Filed: Oct. 31, 2018
(86) PCT No.: PCT/CN2018/112917

§ 371 Date: Apr. 15, 2019

(30) Foreign Application Priority Data
Aug. 27, 2018 (CN) 201810981994.8

(51) Int. Cl. G02F 1/13

(52) U.S. Cl. CPC G02F 1/1309

(57) ABSTRACT

This application provides an ultraviolet alignment illumination system and a detection device for same. The ultraviolet alignment illumination system includes an electronic calculator unit and a power-on device, a power-on device including a probe unit, and the probe unit including a plurality of probe ends.

### BACKGROUND

### Technical Field

This application relates to the liquid crystal alignment field, and in particular, to an ultraviolet alignment illumination system and a detection device for same.

### Related Art

With various advantages such as thin body, power saving, and no radiation, liquid crystal display (LCD) devices have been widely used. Most of the LCD devices on the market are backlight-type LCD devices, including an LCD panel and a backlight module. The working principle of the LCD panel is to place liquid crystal molecules in two parallel glass substrates, control the liquid crystal molecules to change directions by powering on or off the glass substrates, and refract the light of the backlight module to generate a picture.

An alignment control technology of liquid crystal molecules is one of the most important basic technologies for manufacturing LCDs. Quality of a picture displayed on the LCD is related to quality of the liquid crystal alignment, and only a stable and uniform arrangement of liquid crystal materials in the panel can present a high quality picture. Thin layers generally used for oriented arrangement of liquid crystal molecules are referred to as liquid crystal alignment layers.

An ultraviolet meter (UVM), namely, an alignment ultraviolet optical illuminator causes, by means of UV exposure under a power-on condition, liquid crystal-added monomers to form a polymer, and form a liquid crystal pretilt angle on a surface of a polyimide (PI) alignment film, thereby completing the liquid crystal alignment. A UVM power-on mode is to electrically contact a probe on a power-on device with an interface on a substrate, and then supply power to the power-on device by using a computer controlled power supply, to supply power to the substrate.

Contact between a probe unit of the power-on device and a glass signal contact pin is poor, and a position of a gap of the design of a defective segment is not horizontal because an electrical signal enters the defective segment. This easily causes poor contact of a probe and a power-on failure. As a result, a polymerization reaction fails to be produced, easily causing a process of forming a pretilt by using liquid crystal molecules to fail.

Therefore, a main objective of this application is to provide an ultraviolet alignment illumination system and a detection device for same, to further resolve the aforementioned problems.

### SUMMARY

To resolve the foregoing technical problems, an objective of this application is to provide an ultraviolet alignment illumination system, comprising: an electronic calculator unit, configured to send or receive an instruction signal of a power supply unit; and a power-on device, comprising: a probe unit, comprising a plurality of probe ends, each probe end comprising a first probe and a second probe, and the probe ends being configured to respectively come into electrical contact with a plurality of signal input ends of a liquid crystal array substrate during inspection on the liquid crystal array substrate, wherein the power supply unit receives a signal provided by the electronic calculator unit, and outputs a voltage according to a voltage waveform signal edited by the electronic calculator unit.

Another objective of this application is to provide an ultraviolet alignment illumination system, comprising: an electronic calculator unit, configured to send or receive an instruction signal of a power supply unit; and a power-on device, comprising: a probe unit, comprising a plurality of probe ends, each probe end comprising a first probe and a second probe, and the probe ends being configured to respectively come into electrical contact with a plurality of signal input ends of a liquid crystal array substrate during inspection on the liquid crystal array substrate, wherein the power supply unit receives a signal provided by the electronic calculator unit, and outputs a voltage according to a voltage waveform signal edited by the electronic calculator unit; and the power-on device is of an integrated design, so that a base portion of the probe unit of the power-on device maintains at a same level.

Still another objective of this application is to provide an ultraviolet alignment illumination detection device, comprising: a power-on device, comprising: a probe unit, comprising a plurality of probe ends, each probe end comprising a first probe and a second probe, and the probe ends being configured to respectively come into electrical contact with a plurality of signal input ends of a liquid crystal array substrate during inspection on the liquid crystal array substrate; a voltage application unit, comprising a plurality of voltage output ends, and the voltage output ends being connected to the first probes of the probe ends one by one, wherein the voltage application unit applies corresponding voltages to the plurality of signal input ends of the liquid crystal array substrate respectively through the first probes of the probe ends, to perform an imaging test on the liquid crystal array substrate, to determine whether the liquid crystal array substrate is of poor alignment; and an impedance detection unit, comprising a plurality of connection ends, the connection ends being respectively connected to the second probes of the probe ends one by one, wherein the impedance detection unit is configured to: after the imaging test is performed on the liquid crystal array substrate, sense an impedance value between every two of the second probes, to obtain an impedance value between every two of the plurality of signal input ends of the liquid crystal array substrate, to determine whether every two of the signal input ends are short-circuited.

The Objectives of this application are achieved and the technical problems of this application are resolved by using the following technical solutions.

### BRIEF DESCRIPTION OF THE DRAWINGS

FIG. 1 is an exemplary schematic diagram of a probe unit base of a power-on device;

FIG. 2a is a schematic diagram of a probe unit base of a power-on device according to an embodiment of this application;

FIG. 2b is a schematic diagram of a probe unit of a power-on device according to an embodiment of this application;

FIG. 3 is a schematic diagram of an ultraviolet alignment illumination system according to an embodiment of this application; and

FIG. 4 is a schematic diagram of an ultraviolet alignment illumination detection device according to an embodiment of this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference numeral. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further elaborate the technical measures and functions used in the this application to achieve the predetermined invention objectives, specific implementations, structures, features, and functions of a liquid crystal ultraviolet alignment illumination system and a detection device for same that are provided in this application are described in detail below with reference to the accompanying drawings and specific embodiments.

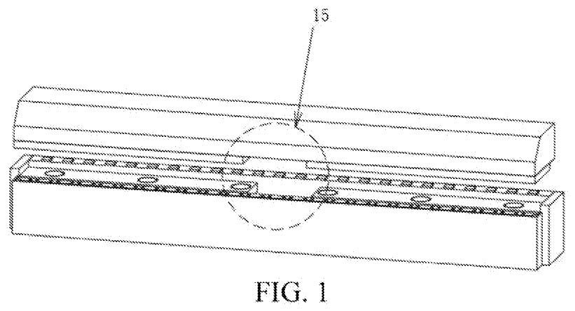

FIG. 1 is an exemplary schematic diagram of a probe unit base of a power-on device. Referring to FIG. 1, contact between the probe unit of the power-on device and a glass signal contact pin is poor, and a position of a gap of the design of a defective segment 15 is not horizontal because an electrical signal enters the defective segment 15. This easily causes poor contact of a probe and a power-on failure. As a result, a polymerization reaction fails to be produced, easily causing a process of forming a pretilt by using liquid crystal molecules to fail.

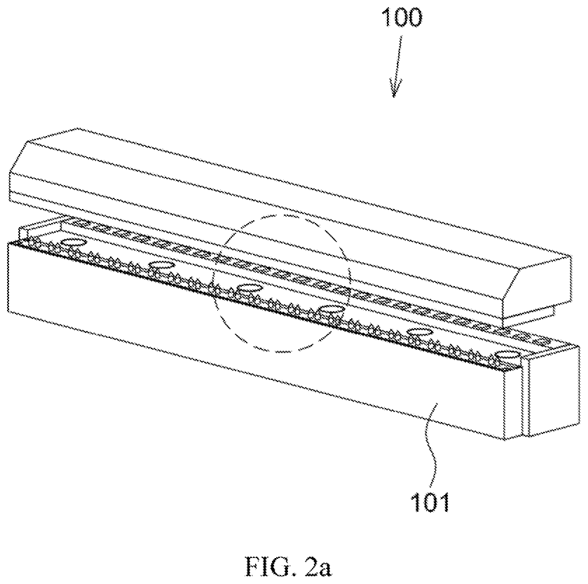

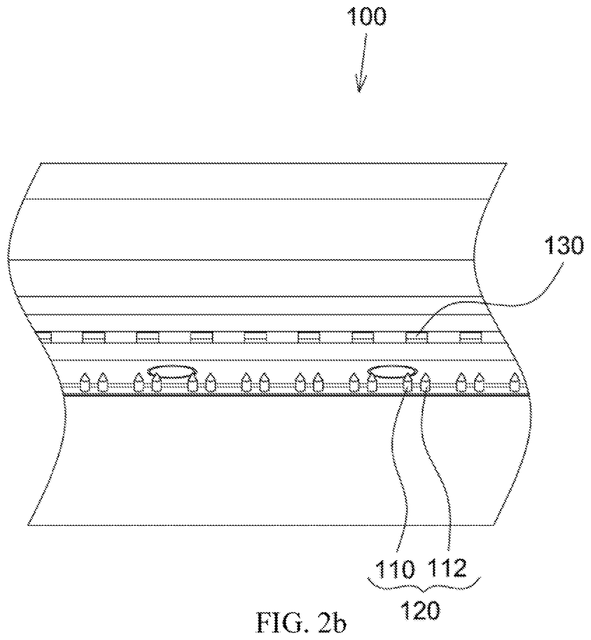

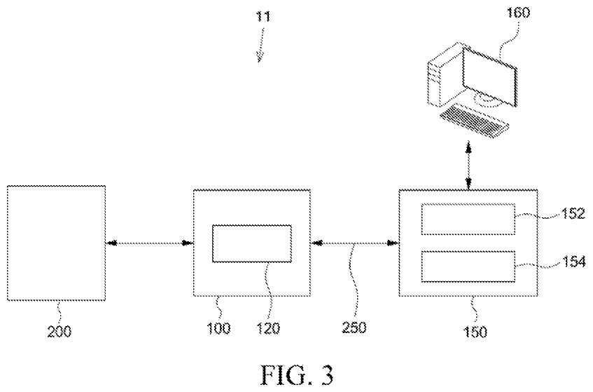

FIG. 2a is a schematic diagram of a probe unit base of a power-on device according to an embodiment of this application. FIG. 2b is a schematic diagram of a probe unit of a power-on device according to an embodiment of this application. FIG. 3 is a schematic diagram of an ultraviolet alignment illumination system according to an embodiment of this application. Referring to FIG. 2a, FIG. 2b, and FIG. 3, in an embodiment of this application, an ultraviolet alignment illumination system 11 includes: an electronic calculator unit 160, configured to send or receive an instruction signal of a power supply unit 150; and a power-on device 100, including: a probe unit 120, including a plurality of probe ends, each probe end including a first probe 110 and a second probe 112, and the probe ends being configured to respectively come into electrical contact with a plurality of signal input ends 130 of a liquid crystal array substrate 200 during inspection on the liquid crystal array substrate 200, where the power supply unit 150 receives a signal provided by the electronic calculator unit 160, and outputs a voltage according to a voltage waveform signal edited by the electronic calculator unit 160.

Referring to FIG. 3, in an embodiment of this application, a military standard connector cable 250 is further included, and configured to connect the power supply unit 150 and the power-on device 100.

Referring to FIG. 3, in an embodiment of this application, the plurality of signal input ends 130 of the liquid crystal array substrate 200 is a color filter common electrode signal input end, a blue-pixel signal input end, a green-pixel signal input end, a red-pixel signal input end, a gate odd-numbered signal input end, a gate even-numbered signal input end, and an array circuit common electrode signal input end.

Referring to FIG. 3, in an embodiment of this application, the power supply unit 150 further includes a direct-current (DC) voltage module 152 and an alternating-current (AC) voltage module 154.

Referring to FIG. 3, in an embodiment of this application, a voltage of the DC voltage module 152 is in a range of 2 V to 10 V.

Referring to FIG. 2a, FIG. 2b, and FIG. 3, in an embodiment of this application, an ultraviolet alignment illumination system 11 includes: an electronic calculator unit 160, configured to send or receive an instruction signal of a power supply unit 150; a power-on device 100, including: a probe unit 120, including a plurality of probe ends, each probe end including a first probe 110 and a second probe 112, and the probe ends being configured to respectively come into electrical contact with a plurality of signal input ends 130 of a liquid crystal array substrate 200 during inspection on the liquid crystal array substrate 200; and a military standard connector cable 250, configured to connect the power supply unit 150 and the power-on device 100, where the power supply unit 150 receives a signal provided by the electronic calculator unit 160, and outputs a voltage according to a voltage waveform signal edited by the electronic calculator unit 160; and the power-on device 100 is of an integrated design, so that a base portion 101 of the probe unit 120 of the power-on device 100 maintains at a same level.

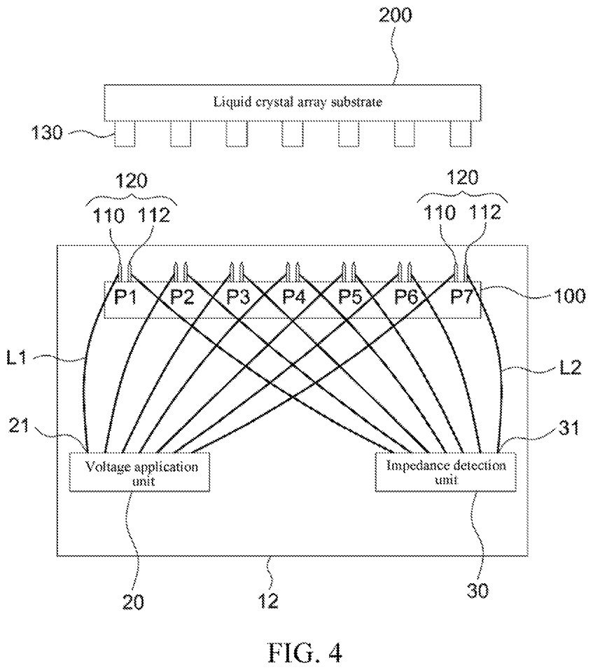

FIG. 4 is a schematic diagram of an ultraviolet alignment illumination detection device according to an embodiment of this application. Referring to FIG. 2a, FIG. 2b, and FIG. 4, in an embodiment of this application, an ultraviolet alignment illumination detection device 12 includes: a power-on device 100, including: a probe unit 120, including a plurality of probe ends, each probe end including a first probe 110 and a second probe 112, and the probe ends being configured to respectively come into electrical contact with a plurality of signal input ends 130 of a liquid crystal array substrate 200 during inspection on the liquid crystal array substrate 200; a voltage application unit 20, including a plurality of voltage output ends 21, and the voltage output ends 21 being connected to the first probes 110 of the probe ends one by one (L1), where the voltage application unit 20 applies corresponding voltages to the plurality of signal input ends 130 of the liquid crystal array substrate 200 respectively through the first probes 110 of the probe ends, to perform an imaging test on the liquid crystal array substrate 200, to determine whether the liquid crystal array substrate 200 is of poor alignment; and an impedance detection unit 30, including a plurality of connection ends 31, the connection ends 31 being respectively connected to the second probes 112 of the probe ends one by one (L2), where the impedance detection unit 30 is configured to: after the imaging test is performed on the liquid crystal array substrate 200, sense an impedance value between every two of the second probes 112, to obtain an impedance value between every two of the plurality of signal input ends 130 of the liquid crystal array substrate 200, to determine whether every two of the signal input ends 130 are short-circuited.

Referring to FIG. 2a, FIG. 2b, and FIG. 4, in an embodiment of this application, the plurality of signal input ends 130 of the liquid crystal array substrate 200 is a color filter common electrode signal input end, a blue-pixel signal input end, a green-pixel signal input end, a red-pixel signal input end, a gate odd-numbered signal input end, a gate even-numbered signal input end, and an array circuit common electrode signal input end.

Referring to FIG. 2a and FIG. 2b, in an embodiment of this application, the power-on device 100 is of an integrated design, so that a base portion 101 of the probe unit 120 of the power-on device 100 maintains at a same level.

Referring to FIG. 2a and FIG. 2b in an embodiment of this application, the first probe 110 and the second probe 112 at each probe end of the probe unit 120 maintains a same height.

In this application, the base of the probe unit of the power-on device is of an integrated design. In the integrated design, there is no gap, the level is good, the probe is in good contact with an electrical signal, and a power-on success rate is high, thereby improving a process yield.

The wordings such as “in some embodiments” and “in various embodiments” are repeatedly used. They usually do not refer to a same embodiment; but they may refer to a same embodiment. The words, such as “comprise”, “have”, and “include” are synonyms, unless other meanings are indicated in the context thereof

The foregoing descriptions are merely embodiments of this application, and are not intended to limit this application in any form. Although this application has been disclosed above through the specific embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. An ultraviolet alignment illumination system, comprising:
an electronic calculator unit, configured to send or receive an instruction signal of a power supply unit; and
a power-on device, comprising:
a probe unit, comprising a plurality of probe ends, each probe end comprising a first probe and a second probe, and the probe ends being configured to respectively come into electrical contact with a plurality of signal input ends of a liquid crystal array substrate during inspection on the liquid array substrate, wherein the power supply unit receives a signal provided by the electronic calculator unit, and outputs a voltage according to a voltage waveform signal edited by the electronic calculator unit.

2. The ultraviolet alignment illumination system according to claim 1, further comprising a military standard connector cable, configured to connect the power supply unit and the power-on device.

3. The ultraviolet alignment illumination system according to claim 1, wherein the plurality of signal input ends of the array substrate is a color filter common electrode signal input end, a blue-pixel signal input end, a green-pixel signal input end, a red-pixel signal input end, a gate odd-numbered signal input end, a gate even-numbered signal input end, and an array circuit common electrode signal input end.

4. The ultraviolet alignment illumination system according to claim 1, wherein the power supply unit comprises an alternating-current (AC) voltage module and a direct-current (DC) voltage module.

5. The ultraviolet alignment illumination system according to claim 4, wherein a voltage of the DC voltage module is in a range of 2 V to 10 V.

6. The ultraviolet alignment illumination system according to claim 1, wherein the power-on device comprises a voltage application unit, comprising a plurality of voltage output ends, and the voltage output ends being connected to the first probes of the probe ends one by one.

7. The ultraviolet alignment illumination system according to claim 6, wherein the voltage application unit applies corresponding voltages to the plurality of signal input ends of the liquid crystal array substrate respectively through the first probes of the probe ends, to perform an imaging test on the liquid crystal array substrate, to determine whether the liquid crystal array substrate is of poor alignment.

8. The ultraviolet alignment illumination system according to claim 1, wherein the power-on device comprises an impedance detection unit, comprising a plurality of connection ends, the connection ends being respectively connected to the second probes of the probe ends one by one.

9. The ultraviolet alignment illumination system according to claim 8, wherein the impedance detection unit is configured to: after an imaging test is performed on the liquid crystal array substrate, sense an impedance value between every two of the second probes to obtain an impedance value between every two of the plurality of signal input ends of the liquid crystal array substrate, to determine whether every two of the signal input ends are short-circuited.

10. An ultraviolet alignment illumination system, comprising:
an electronic calculator unit, configured to send or receive an instruction signal of a power supply unit; and
a power-on device, comprising:
a probe unit, comprising a plurality of probe ends, each probe end comprising a first probe and a second probe, and the probe ends being configured to respectively come into electrical contact with a plurality of signal input ends of a liquid crystal array substrate during inspection on the liquid crystal array substrate, wherein the power supply unit receives a signal provided by the electronic calculator unit, and outputs a voltage according to a voltage waveform signal edited by the electronic calculator unit;
and the power-on device is of an integrated design, so that a base portion of the probe unit of the power-on device maintains at a same level.

11. The ultraviolet alignment illumination system according to claim 10, wherein the power-on device comprises a voltage application unit, comprising a plurality of voltage output ends, and the voltage output ends being connected to the first probes of the probe ends one by one.

12. The ultraviolet alignment illumination system according to claim 11, wherein the voltage application unit applies corresponding voltages to the plurality of signal input ends of the liquid crystal array substrate respectively through the first probes of the probe ends, to perform an imaging test on the liquid crystal array substrate, to determine whether the liquid crystal array substrate is of poor alignment.

13. The ultraviolet alignment illumination system according to claim 10, wherein the power-on device comprises an impedance detection unit, comprising a plurality of connection ends, the connection ends being respectively connected to the second probes of the probe ends one by one.

14. The ultraviolet alignment illumination system according to claim 13, wherein the impedance detection unit is configured to: after an imaging test is performed on a liquid crystal array substrate, sense an impedance value between every two of the second probes, to obtain an impedance value between every two of a plurality of signal input ends of the liquid crystal array substrate, to determine whether every two of the signal input ends are short-circuited.

15. An ultraviolet alignment illumination detection device, comprising:
a power-on device, comprising:
a probe unit, comprising a plurality of probe ends, each probe end comprising a first probe and a second probe, and the probe ends being configured to respectively come into electrical contact with a plurality of signal input ends of a liquid crystal array substrate during inspection on the liquid crystal array substrate;
a voltage application unit, comprising a plurality of voltage output ends, and the voltage output ends being connected to the first probes of the probe ends one by one, wherein the voltage application unit applies corresponding voltages to the plurality of signal input ends of the liquid crystal array substrate respectively through the first probes of the probe ends, to perform an imaging test on the liquid crystal array substrate, to determine whether the liquid crystal array substrate is of poor alignment; and
an impedance detection unit, comprising a plurality of connection ends, the connection ends being respectively connected to the second probes of the probe ends one by one, wherein the impedance detection unit is configured to: after the imaging test is performed on the liquid crystal array substrate, sense an impedance value between every two of the second probes, to obtain an impedance value between every two of the plurality of signal input ends of the liquid crystal array substrate, to determine whether every two of the signal input ends are short-circuited.

16. The ultraviolet alignment illumination detection device according to claim 15, wherein the plurality of signal input ends of the liquid crystal array substrate is a color filter common electrode signal input end, a blue-pixel signal input end, a green-pixel signal input end, a red-pixel signal input end, a gate odd-numbered signal input end, a gate even-numbered signal input end, and an array circuit common electrode signal input end.

17. The ultraviolet alignment illumination detection device according to claim 15, wherein the power-on device is of an integrated design, so that a base portion of the probe unit of the power-on device maintains at a same level.

18. The ultraviolet alignment illumination detection device according to claim 15, wherein the first probe and the second probe at each probe end of the probe unit maintains a same height.
